(19) United States
(12) Patent Application Publication
(10) Pub. No.: US 2009/0272805 A1
(43) Pub. Date: Nov. 5, 2009

(54) Interactive Holographic Security Element

(75) Inventors: Rodney Riddle, Dorset (GB); Michael Weiden, Darmstadt (DE)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Smart Holograms Limited

(21) Appl. No.: 12/225,457

(22) PCT Filed: Oct. 4, 2006
(86) PCT No.: PCT/EP2006/009575

§ 371 Date: Dec. 16, 2008

(30) Foreign Application Priority Data
Oct. 11, 2005 (EP) 05022076.3

(51) Int. Cl. G06K 7/10; G06K 19/00

(52) U.S. Cl. 235/457; 235/487; 235/491; 235/490

(57) ABSTRACT

The present invention relates to an interactive security element comprising at least one volume hologram the latter being responsive to at least one applied external stimulus and exhibits a defined optical effect in form of an image, whereby the optical effect in form of an image is preferably different when being observed at different angles of view and the different images may be observed at least after an external stimulus has been applied, to a method of verifying said interactive security element as well as to the use thereof for verification, identification, authentication or anti-counterfeiting purposes, in particular as a public feature to security products such as banknotes, passports, identification documents, tickets, credit cards, smart cards, etc., and for brand and production protection.

The present invention relates to an interactive security element comprising at least one volume hologram the latter being responsive to at least one applied external stimulus and exhibiting at least one defined optical effect in the form of an image. Preferably, the optical effect in the form of an image is different when being observed at different angles of view and different images may be observed at least after an external stimulus has been applied.

The interactive security element of the present invention is particularly useful for verification, identification, authentication or anti-counterfeiting purposes and may be applied as a public feature to any known product which has to be secured, in particular as brand protection or to security products such as banknotes, passports, identification documents, tickets, credit cards, smart cards etc.

Diffractive elements such as embossed holograms have widespread use as protective features in the security and brand protection industry. When being used as public features, the level of security and protection which these elements provide is limited. Whereas a person skilled in the art who deals with development and/or verification of security elements may be in a position to differ between original and counterfeited products, the so called “person in the street” may not be aware of the slight differences exhibited by holograms used in counterfeited products, even not in a direct comparison with the original product. Furthermore, the standard type of security holograms in current use may now be copied and easily made in large quantities using commercial equipment that is readily available.

Typical kinds of holograms which have been used heretofore in the security industry are thin holograms and surface holograms which are easy to produce and provide impressive optical effects but show, nevertheless, the disadvantages mentioned above.

Although not in common use nowadays, volume holograms have also already been used in the security industry.

EP 0 466 118 A2 discloses a multilayered optical variable element, preferably a hologram, which comprises a stable and thin covering layer, making the transfer of the hologram to a substrate easy. The multilayer structure may contain an embossed and metallized hologram or a volume hologram. The volume hologram is harder to copy than the embossed hologram, but shows no optical effects which are different from those of the embossed hologram. Therefore, it may not easily be evaluated by the general public.

A process for forming a multicolour volume phase hologram in a substantially solid, transparent, photosensitive film element is described in EP 0 529 459 A1. The recording of the volume hologram is done image wise in order to obtain a multicoloured hologram which may be used, amongst others, in security applications. Such volume holograms are multicoloured when viewed at one single angle of view. Therefore, their optical impression is better than that of monocoloured holograms. Additionally, their resistance to copying is improved. Nevertheless, it is difficult for the public to distinguish between original and copy, if there is not a genuine original available for comparison.

EP 1 217 469 A2 discloses a method for producing a holographic optical element comprising primary and complementary holograms. The holographic optical element contains a volume hologram, is useful as a security device and is advantageous since it exhibits two different colours when being tilted. These holographic elements are relatively easy to produce and are almost impossible to copy. When used as a public feature, a direct comparison between original and copy seems still to be necessary in order to evaluate the validity of the hologram.

In EP 0 919 961 B1 a security element for documents is described, which includes a volume hologram showing a kinetic effect and wherein local areas of the volume hologram are shrunk or swollen after the recording of the volume hologram, so that the Bragg network planes in these regions are correspondingly changed. Due to these partially shrunk or swollen areas of the volume hologram, which might not be recognised by an observer, an additional anti-copying effect can be achieved. Thus, only parts of the hologram, if any, can be copied. Volume holograms showing such a kinetic effect are not easily produced and the shrinking or swelling of defined parts of the Bragg network planes, which follows, makes the production process even more complicated.

WO 03/099581 discloses a security element being composed of a surface hologram in combination with a volume hologram. In order to enhance the resistance to copying, the volume hologram may slightly be shrunk or swollen at several parts, leading to interference effects (moiré) within the hologram.

Such combinations of different kinds of holograms cannot easily be produced, in particular when both holograms shall bear the same image. Furthermore, when the original is missing, it is questionable whether the public may recognise a copy due to the moiré effect.

A general overview regarding the technical background with respect to the use of holograms in security applications can be found in “Optical Document Security” by Rudolf L. van Renesse (Editor), Artech House Boston-London, Second Edition 1998, ISBN 0-89006-9824, chapters 4.4 (holography), 10 (document protection by holograms) and 11 (document protection by optically variable graphics (kinegrams)).

Although holograms have widespread use as security devices, there remains a demand for security holograms which are easy to produce, can only be copied with great difficulty, show outstanding optical effects and may easily be evaluated with respect to their validity, especially by the general public, the so called “person in the street”.

It has, therefore, been the object of the present invention to provide a security element in the form of a hologram which may be produced in a relatively easy process at low cost, may be copied only with great difficulty, exhibits outstanding optical effects and can be used as an easily recognisable public feature which can be evaluated with respect to validity without the need of having an original specimen for comparison and preferably without additional helping means.

A further object of the present invention has been to provide a method for the verification of said security element.

Additionally, it has been another object of the present invention to use said security element in different security applications.

The object of the present invention is resolved by an interactive security element comprising at least one volume hologram, wherein the volume hologram is responsive to at least one applied external stimulus and exhibits at least one defined optical effect in the form of an image, at least after the application of said at least one external stimulus to the volume hologram.

Preferably, the interactive security element is one wherein the optical effect in the form of an image may be observed by using an optical detector at a first viewing angle and wherein a second image which is different from the first image may be observed using an optical detector at a second viewing angle which is different from the first viewing angle.

Furthermore, the object of the present invention is resolved by a method for the verification of said security element by an observing unit exhibiting a viewing position with respect to the security element, comprising
illuminating the security element by a light source,
observing an optical effect in form of a first image at a first viewing angle by using an optical detector,
tilting or otherwise changing the position of the security element relative to the observing unit or changing the viewing position of the observing unit to achieve at a second viewing angle which is different from said first viewing angle,
observing a second image at the second viewing angle using an optical detector and
comparing said first image with said second image.

Additionally, the object of the present invention is resolved by a further method for the verification of said security element by an observing unit exhibiting a viewing position with respect to the security element, comprising
illuminating the security element by a light source,
observing an optical effect in the form of a first image at a first viewing angle by using an optical detector,
applying an external stimulus to said security element without altering the position of the security element or the viewing position of the observing unit,
observing an optical effect in the form of a further image at said first viewing angle by using an optical detector and
comparing said first image with said further image.

Still furthermore, the object of the present invention is resolved by the use of the above described security element for verification and/or identification and/or authentification and/or anti-counterfeiting purposes.

In order to be useful as a valuable public feature, a hologram must exhibit outstanding optical effects which may easily be recognised by the so called “person in the street” and preferably, the validity of such a hologram must be recognisable immediately, preferably without the help of additional means which are not usually carried by any person. Furthermore, considering identity cards, credit cards, driving licenses or even bank notes, it is unlikely that a person who wants to check the validity of such a document will always have an original document for comparison in hand. Therefore, it must be possible to check the validity of such a document without a comparison sample.

The interactive security element of the present invention fulfils these requirements in an outstanding manner, because it is responsive to at least one applied external stimulus and it shows at least one optical effect in the form of an image, which may be observed at least after the stimulus has been applied. In the simplest form, the external stimulus is at least one of humidity, water, temperature, pressure or light. Most of these stimuli can be readily provided by the “person in the street”, for example by his breath, body temperature, rubbing or pressure of a finger, different light sources, some drops of water, etc. Furthermore, in a preferred embodiment, an optical detector which is used when checking the security element is the naked eye. At least after one of the external stimuli mentioned above has been applied to the security element, at least one defined optical effect in the form of an image may be observed. Therefore, an immediate check of the validity of a security product comprising the security element of the present invention is possible by anybody.

The interactive security element of the present invention comprises a volume hologram which is responsive to at least one applied external stimulus and exhibits at least one defined optical effect in the form of an image. For the purposes of this invention, “responsive” means that the volume hologram interacts with the external stimulus to such an extent that an image which is observable when the interactive security element is illuminated alters after the application of the external stimulus or that no image may be observable prior to the application of an external stimulus whereas after the application of an external stimulus an image is observable, or a combination of both.

In general, at least one of the following is applied as an external stimulus: humidity, water, gases, vapours, organic solvents, chemicals, solutions or dispersions of chemicals, pressure, temperature, light of particular wave-lengths, magnetism, electrical field, electrical charge, electrical potential, non-ionising radiation, electromagnetic radiation, radioactive radiation, enzymes, biological materials and combinations of two or more thereof. All these stimuli may also vary in degree or intensity, irrespective of whether being used singly or in combination.

Of course, not all of these stimuli are available to everyone at all times. Therefore, to a certain extent, at least in some embodiments, the security element of the present invention will not be recognisable in all aspects by everybody. Thus, a combination of several stimuli causing different images will enhance the degree of security of the security element of the present invention, in particular when some of these stimuli may only be applied by a person skilled in the art.

It has been mentioned before that the validity of the security element according to the present invention must be immediately recognisable when being used as a valued public feature. Thus, the reaction time of the volume hologram to an applied external stimulus must be very short. In general, the reaction time of the volume hologram after the external stimulus has been applied is between one tenth of a second and several seconds, in particular from 0.1 to 10 seconds.

Preferred are external stimuli like humidity, water, solutions or dispersions of chemicals, pressure, temperature and light of particular wavelengths, in particular humidity, water, or combinations of temperature with pressure or light.

The interactive security element according to the present invention exhibits at least one defined optical effect in the form of an image. For the purpose of the present invention, the term “image” is defined as being a holographic representation of an object.

Such an object may comprise, but is not limited to, a mirror, a reflective surface, an alphanumeric or other character, a microtext, a picture, a photo, a bar code, a physical object, a logo, a trade mark, a computer generated picture, a computer generated object and projections thereof. It goes without saying that one or more of these objects may be used in combination.

For the purpose of this invention, the term “alphanumeric or other character” means any character which is used worldwide to provide written information such as singular characters, words, sentences, descriptions, pictograms, numbers, mathematical relations etc., including Latin, Arabic, Chinese, Japanese, Korean or similar characters.

In a particularly preferred embodiment, the image which is exhibited by the security element may be observed by using an optical detector at a first viewing angle and at a second viewing angle a second different image, which differs from the first image, may be observed, when another optical detector is used, being of the same or of a different kind as the first optical detector. The second viewing angle may be achieved, for example, by tilting or otherwise changing the position of the security element relative to the observing unit whereas the viewing position of the observing unit is maintained or by changing the viewing position of the observing unit, whereas the position of the security element is maintained. Of course, both the viewing position of the observing unit as well as the position of the security element may be changed, but in the latter case it will be difficult to detect whether the viewing angle has indeed been changed.

Additionally, one or more further images may be observed at one or more further viewing angles being different from the first and second viewing angles. These further images may be revealed by simply moving the interactive security element of the present invention using any kind of possible movement, e.g. up and down movement, circular movement or any other movement relative to the observing unit, by movement of the observing unit or by movement of the light source. The further images which may be observed at these further viewing angles are due to the action of the volume hologram itself, since it is possible to record a number of images in a volume hologram regardless of whether it is responsive to stimuli or not. Preferably, such further images may be observed prior to the application of any stimulus. For the purposes of the invention, merely the behaviour of the images which may be observed under the first and second viewing angles shall be described in detail, in order to explain the present invention in a clear and reasonable manner.

For the purpose of this invention, the term “observing unit” is meant to be a person or an optoelectronic verification appliance, e.g. a camera system or a hand-held optical detector described below. Such an observing unit exhibits, of course, a particular viewing position relative to the position of the security element, i.e. its viewing position is directed to the security element so that an observation of the security element is possible.

For the purpose of this invention, the term “different image” means, that the images which may be observed at said first and/or second viewing angle are different in colour and/or intensity and/or brightness and/or object and/or position and/or orientation and/or size and/or apparent depth and/or perspective and/or parallax. Therefore, not only holographic representations of different objects, e.g. bar-codes, logos, trade marks, etc. are regarded as being different images, but also for instance a particular logo, which alters in colour, the intensity of the colour, its brightness, its position, its orientation, its size and/or its apparent depth on the security element, due to the application of at least one external stimulus.

Of course, the definition of the “different image” does also apply for the additional images which may be observed at the further viewing angles which are different from the first and second viewing angles.

An “optical detector” in the sense of the present invention is in the simplest form the naked eye, or the naked eye assisted by spectacles, magnifying lenses, microscopes, lenticular lenses, polarizing filters, diffractive structures, wavelength filter elements or light enhancing systems. Further optical detectors may be, but are not limited to spectrophotometers, spectrum analysers, CCD-sensors, CMOS-sensors, OCR-readers, bar code readers, cameras and image recognisers. Of course, these optical detectors may be used singly or in combination of two or more of them, depending on the kind of image which has to be observed.

The image which may be observed at the first viewing angle and a second different image at a second viewing angle may be observed either prior to the application of at least one external stimulus or after the application of an external stimulus or in both cases.

Additionally, an image may be observed at the first viewing angle prior to the application of an external stimulus and a second different image may be observed at the second viewing angle after the application of at least one external stimulus.

Thus, the following cases have to be borne in mind:

In the first embodiment, wherein prior to the application of an external stimulus a first image may be observed at a first viewing angle and after the application of an external stimulus a second different image may be observed at the second different viewing angle. The second viewing angle has been achieved by changing the relative position of the security element with respect to an observing unit, e.g. by tilting, or by changing the viewing position of an observing unit.

For illustration, one can imagine a security element which shows a particular image at one first viewing angle, e.g. a logo, and after the application of an external stimulus, e.g. some drops of water, a second different logo appears when the security element is viewed at a second viewing angle.

In the second embodiment, wherein prior to the application of an external stimulus no image may be observed at a first and a second viewing angle, respectively, and after the application of an external stimulus a first image may be observed at said first viewing angle and a second image may be observed at said second viewing angle, using an optical detector, whereby the second image differs from the first image.

Thereby, the second viewing angle, which is different from the first viewing angle, has been achieved by e.g. tilting the security element whereas the viewing position of the observing unit is maintained or by changing the viewing position of the observing unit, whereas the position of the security element is maintained.

For illustration, one can imagine a security element which does not show any image on a particular part thereof and as soon as an external stimulus, e.g. some drops of water, have been applied, the particular part of the security element exhibits an image in the form of, e.g., a logo at one first viewing angle and after the security element has been tilted or after the observing unit, e.g. a person, has changed its viewing position in order to achieve at a second viewing angle, the person may observe a logo image which differs from the first in colour, the intensity of the colour, its bright-ness, its position, its orientation, its size, its perspective, its parallax and/or its apparent depth on the security element, or may observe a different logo or picture at the second viewing angle.

In a third embodiment, prior to the application of an external stimulus a first and a second different image may be observed at a first and a second viewing angle, respectively, and after the application of an external stimulus a third image is revealed which may also be observed at said first viewing angle. In this case, the third image is different from the first image and both images may be observed at the same viewing angle, the first image prior to the application of an external stimulus and the third image after the application of an external stimulus.

Taking a similar example as described above, the particular part of the security element exhibits, prior to the application of an external stimulus, an image in the form of a logo at one first viewing angle and after the security element has been tilted or after the observing unit has changed its viewing position, a picture may be observed at a second viewing angle. Afterwards, some drops of water are applied as an external stimulus, and at the first viewing angle a further logo, which is different from the first one, is revealed at the first viewing angle.

In a fourth embodiment, prior to the application of an external stimulus a first and a second different image may be observed at a first and a second viewing angle, respectively, and after the application of an external stimulus a third image is revealed which may also be observed at said first viewing angle and a fourth image is revealed which may be observed at said second viewing angle.

Staying with the examples mentioned above, the particular part of the security element exhibits, prior to the application of an external stimulus, an image in the form of a logo at one first viewing angle and after the security element has been tilted or after the observing unit has changed its viewing position, a picture may be observed at a second viewing angle. Afterwards, some drops of water are applied as an external stimulus, and at the first viewing angle a further logo, which is different from the first one, is revealed and a second picture, which is different from the first one, is revealed at the second viewing angle.

Of course, several external stimuli may be applied to the security element according to the present invention, preferably one after another.

To this end, the different embodiments mentioned above are repeated and after the application of the first external stimulus, leading to different images at said first and/or second viewing angle, a second, third, fourth etc. external stimulus is applied to the security element, whereupon further different images are revealed at the first and/or second viewing angles.

Thus, the application of n different external stimuli to the security element according to the present invention leads to the revelation of z images which may be observed at said first viewing angle, wherein n and z are cardinal numbers equal or greater than 1 and are different or equal to each other.

Of course, the application of those n different external stimuli may also lead to different images at said second viewing angle, the number of which shall not be defined here, because it is of minor importance.

The images are not limited to logos and pictures as described for illustration above, but may be of all kinds of objects as defined before.

The volume hologram within the interactive security element according to the present invention is composed of a polymeric support medium having a light diffractive structure therein and exhibiting at least one change or variation in at least one physical property of the polymeric support medium and/or the light diffractive structure when an external stimulus is applied.

In a volume hologram or a volume type phase hologram, a light diffractive structure is usually created by the interference of at least two mutually coherent optical beams of a particular wavelength over the volume of a photosensitive material.

The volume hologram of the present invention may be composed of a polymeric support medium having a photosensitive material disposed therein, the latter being able to create a light diffractive structure throughout the volume hologram when at least two mutually coherent optical beams of a particular wavelength are applied thereto and after any necessary processing.

Therefore, in the simplest way, the volume hologram of the present invention is composed of photosensitive silver halide particles in a polymeric medium, which may be of gelatin. To this end, the grain size of the silver halide particles should be controlled, since too large particles are not useful for the purposes of the present invention. Preferably, the grain size of the silver halide particles is in the range of from 5 to 50 nm, especially of from 10 to 40 nm and most preferably in the range of from 10 to 30 nm. Gelatin is a standard matrix material for supporting photosensitive species, especially silver halide grains. Gelatin can also be photo-cross-linked by chromium (III) ions, between carboxyl groups or gel strands.

Other examples of holographic support media are K-carageenan, starch, agar, agarose, polyvinyl alcohol (PVA), sol-gels (as broadly classified), hydrogels (as broadly classified), and acrylates. Further materials are polysaccharides, proteins and proteinaceous materials, oligonucleotides, RNA, DNA, cellulose, cellulose acetate, polyamides, polyimides and polyacrylamides.

Typical polymers can be selected from polyvinyl alcohol, polyvinyl pyrrolidone, polyhydroxyethyl acrylate, polyhydroxyethyl methacrylate, polystyrenes, functionalised polystyrenes, polyacrylamides, polymethacryl-amides, homopolymers or copolymers of polymerisable derivatives of crown ethers, and esters of or co- or terpolymers of polyhydroxyethyl acrylate, polyhydroxyethyl methacrylate, polymethacrylamide or polyacrylamide, optionally with other polymerisable monomers or cross linkers.

In particular, copolymers of, e.g. (meth)acrylamide and/or (meth)acrylate-derived monomers are used, which may be crosslinked. Preferably, hydroxyethyl methacrylate monomer is readily polymerisable and cross-linkable. Polyhydroxyethyl methacrylate is a versatile support material since it is swellable and hydrophilic.

The photosensitive material such as silver halides may be disposed in the support medium by dispersing silver halide grains within a low viscosity precursor of the support medium, followed by either solidification and/or crosslinking of the support medium. Alternatively, a sequential treatment technique can be used, wherein the polymer film is made first and sensitive silver halide particles are added subsequently. These particles are introduced into the support medium by diffusing soluble salts into the polymer matrix where they react to form an insoluble light-sensitive precipitate. The holographic image is then recorded.

Different liquids, such as e.g. water, aqueous solutions of NaNO₃ or other soluble salts, aqueous solutions of alcohols, such as ethanol or isopropanol, solutions of triethanolamine and solutions of polyethylene glycol, in different concentrations, are able to alter the volume of the support medium, causing its contraction or expansion. Therefore, the holographic image in the volume hologram of the present invention can be recorded after immersing the support medium containing the photosensitive material, e.g. the silver halide particles, in an appropriate liquid, thereby leading to contraction or expansion of the support medium. Additionally, applying different liquids, e.g. those mentioned above, optionally in different concentrations, to different parts of the support medium prior to the recording of the volume hologram may therefore lead to a different response of these parts of the volume hologram to an external stimulus. To this end, in particular multicoloured images of the volume hologram may be obtainable.

The polymer composition may be optimised to obtain a high quality film, suitable for the preparation of a hologram. The film should allow for the production of a uniform matrix, in which holographic fringes can be formed.

If appropriate, the polymeric support medium can also contain pores. Such media are obtainable by formation of the support medium in situ in the presence of a pore-forming agent, e.g. by polymerisation of monomers to a polymer in situ in the presence of a pore forming agent such as gas, liquid, water etc.

The polymeric support medium of the volume hologram need not necessarily contain silver halide particles in order to have a diffractive structure recorded therein. The polymeric support medium may instead have a polymeric holographic element disposed throughout the volume thereof, wherein the fringes of the holographic element are defined by different degrees of swellability in a liquid. These different degrees of swellability may correspond to different degrees of polymerisation or cross-linking of the polymeric medium.

Such holograms are produced by a process where in a first step a polymeric matrix is formed, and in the second step, in selected parts of the matrix, a different degree or type of polymerisation is caused, optionally involving a further cross-linking step.

The second step may not of itself form a distinct holographic grating, but a grating will be evident on swelling or contraction of the resultant material. Thus, the volume hologram of the present invention may comprise at least two polymers distinguished in type or degree of cross-linking (the cross-linking may also be zero). These polymers may be regarded being either “soft” or “hard”, depending on the degree of cross-linking. Either all, some or each of such polymers may include functional groups that are intended to react with an external stimulus.

The holographic fringes, which are relatively lightly cross-linked, are able to swell when being contacted with an appropriate external stimulus, whereas the heavily cross-linked fringes are not. Such swelling may lead to either alteration in the difference of the refractive indices of both polymers or to difference of fringe spacing between that of recording and that of replay.

In case the resulting volume hologram should be responsive to more than one external stimulus, the polymeric support medium may be composed of a layered structure, each layer comprising a different material. Alternatively, the support medium may consist of different materials lying concentrically adjacent to each other throughout their depth.

The polymeric support medium of the volume hologram may also be a so called phase-change polymeric medium, changing for example the degree of opacity/transparency by changing physical parameters. The temperature and pressure dependent phase-change polymers known in the art may be used.

Other non-silver halide based holographic recording materials which are known in the art may also be used as recording medium, i.e. polymeric support including a recording element, of the present invention. These include photopolymerisable systems as well as photoreactive, photo-chromic or photorefractive systems that are employed in data storage. Whilst well established as holographic recording materials, these materials have heretofore not been used as materials which are sensitive to external stimuli. Several kinds of such photopolymerisable materials have been used e.g. by companys such as Polaroid or DuPont de Nemours for recording purposes.

Furthermore, gelatine crosslinking by chromium ions has been mentioned before. It is well known that dichromated gelatine has been used in the past as suitable holographic recording material. Thus, it is also applicable for the purpose of the present invention, although the toxicological properties of chromium limit the use of the system and the need to seal the holograms to prevent exposure to moisture will exclude any solution based stimuli. Despite this, holograms which react to physical stimuli such as temperature or pressure will still be possible.

Volume holograms which are usable for the security element of the present invention may be prepared according to the methods described e.g. in WO 95/026499, WO 99/063408, WO 01/050113 or WO 03/087789.

The volume hologram, being part of or constituting the interactive security element of the present invention, is typically thicker than the spacing of the interference fringes within the holographic structure created in the polymeric support medium. The volume hologram has, therefore, a lateral dimension up to some centimetres and a thickness ranging from 5 μm up to a few millimetres, preferably from 5 to 500 μm, more preferably from 10 to 50 μm, and in particular from 6 to 30 μm.

The volume hologram has at least two Bragg layers therein and may include up to some 100 Bragg layers, preferably 5 to 50 Bragg layers, more preferably 5 to 40 Bragg layers, and in particular 5 to 20 Bragg layers. For example, a volume hologram having a thickness of 10 to 20 μm will usually include 5 to 40 Bragg layers.

A Bragg layer is defined as a layer which, after the imprinting process, causes locally restricted changes of the refractive index within the volume hologram when at least two mutually coherent optical beams are interfered and, therefore, may be considered as equivalent to an interference fringe. The Bragg layers or interference fringes form a light diffractive structure within the volume hologram.

The volume hologram alters the propagation of the illumination to which it is exposed, but requires precise adjustments for wavelength and direction of the light and media (Bragg selectivity). The Bragg effect does, therefore, mean that the volume hologram will change its optical performance when the spacing between the interference fringes is altered.

The volume hologram within the interactive security element according to the present invention exhibits at least one change or variation in at least one physical property of the polymeric support medium and/or the light diffractive structure when an external stimulus is applied.

Such physical property is one or more of size, shape, density, strength, hardness, hydrophobicity, swellability, integrity, polarizability, charge distribution and combinations thereof.

In this case integrity is meant as the regularity of the structure of the hologram throughout the support medium and modulation depth of the fringes defining the hologram. Such a structure may be destroyed by the action of an external stimulus, e.g. when the external stimulus is a chemical, a solution or dispersion of a chemical, an enzyme or a biological material. In the latter case, the chemical reaction caused by these external stimuli may cleave bonds at specific sites in the polymeric support medium, thus destroying the structure of the hologram. Similarly, the integrity of the polymeric support medium and/or the light diffracting structure may also be destroyed by degradation or re-ordering of the support medium due to a reaction to an external stimulus.

The other terms mentioned above are self explanatory, i.e. size means size of the holographic support medium or size of the light diffractive structure, shape means shape of the holographic support medium or shape of the light diffractive structure, polarizability means polarizablity of components of the holographic support medium or polarizablity of components of the light diffractive structure, charge distribution means charge distribution within the holographic support medium or charge distribution within the light diffractive structure, swellability means solvent swellability of the holographic support medium or solvent swellability of the light diffractive structure etc.

The interaction of at least one of the external stimuli mentioned above with the security element comprising at least one volume hologram according to the present invention causes a chemical or physical reaction within the volume hologram, whereupon one or more of size, shape, density, strength, hardness, hydrophobicity, swellability, integrity, polarizability or charge distribution of the polymeric support medium and/or of the light diffractive structure therein are changed or varied.

In most cases, such changes or variation are caused by alteration of the volume and/or density of the polymeric support medium or of the holo-graphic interference fringes. Additionally or alternatively, molecule shape or molecular order of the polymeric materials may change.

Of course, merely parts of the volume hologram (support medium and/or diffractive structure) may be altered by the application of an external stimulus. Therefore, some parts of the hologram may change and some parts may not change or may change in a different way.

The changes in the physical properties mentioned above cause alterations in the structure of the volume hologram, which lead to at least one change or variation in the reflectance and/or refractance and/or absorbance and/or polarizability of the light diffractive structure which are observable when the volume hologram is illuminated by a light source and when an optical detector is used.

In the simplest case, the optical detector is the naked human eye. Other kinds of optical detectors which may be used are described above.

Since the optical properties of a volume hologram are proportional to the refractive indices of the materials of which the volume hologram is composed, changes of the refractive index in the polymeric support medium or in the diffractive structure contained therein, which are caused by an interaction with an external stimulus, may be observed. In a preferred embodiment, the refractive index is changed by swelling or contracting of the support medium and hence of the diffractive structure due to the application of an external stimulus.

In the same way, the reflection, absorption or polarization properties of a material used in the volume hologram according to the present invention may be changed or varied by the influence of an external stimulus. All of these changes or variations cause alterations in the optical performance of the volume hologram of the present invention, which might be observed. The change or variation in at least one physical property of the polymeric support medium and/or the light diffracting structure may be reversible, partly reversible or irreversible.

The volume hologram being part of or constituting the interactive security element of the present invention is applied to a substrate. Such a substrate may be either the substrate of the security element itself or a substrate which is part of the security element, e.g. a layer or part of a layer within the structure of the security element.

Typical substrates are transparent or opaque, flexible, semi-rigid or rigid and may be of glass, polymers, in particular plastics, paper of any kind, paper board, fibrous materials, metals laminates of paper and plastics, optionally containing both materials in combination, laminates of paper and plastics with other appropriate materials such a metal or wood, and have a planar surface or any appropriately shaped surface.

In order to enhance the visual effect of the volume hologram, an absorbing (i.e. black or dark coloured) and/or reflecting background for the volume hologram is preferred. Therefore, the surface of the substrate lying underneath the volume hologram on the side thereof which is not illuminated should preferably exhibit absorbing or reflecting characteristics or a combination of both. In the latter case, of course the support medium as well as the diffractive structure of the hologram should be at least partly transparent.

Preferably, such absorbing and/or reflecting layers are made of materials which are usually used for such purposes in the holographic industry, e.g. layers of metals such as aluminium, dark coloured layers containing absorbing materials such as inorganic or organic pigments, or the like. When such a combination of an absorbing or reflecting background and of a transparent holographic structure is used, the observable changes in the optical behaviour of the volume hologram are very impressive and may be observed easily, even by the naked eye.

The interactive security element of the present invention comprises at least one volume hologram, but may also comprise two or more volume holo-grams which are interactive to the same external stimulus or to different external stimuli or to the same external stimuli in different sequence.

At least one part of the interactive security element of the present invention is in the form of a volume hologram. Alternatively, the security element consists of a volume hologram as described above.

The security element itself may exhibit a form being useful in the known applications of security elements, e.g. may be a label and/or a patch and/or a stripe and/or a thread. Of course, a label in addition to a rectangular shape may exhibit any appropriate shape.

Usually, security elements in form of labels, patches, stripes and/or threads are applied to the surface of a product which has to be secured. Therefore, also the security element of the present invention may be applied to the surface of a product. This might be done by nearly any known process such as by the help of an adhesive, a pressure-sensitive adhesive, a hot-melt adhesive, a reactive or partly reactive hot-melt adhesive or combinations thereof.

Such adhesives are selected so as to ensure that a permanent bond to the surface of the product is achieved. In this way it is possible to avoid the later illicit removal of the multiple security means from the surface of the product. Methods known as tamper evident systems are used to achieve destruction of the multiple security means in the event that illicit removal is attempted. Any adhesives used should also not affect the performance of the multiple security means.

Such processes as well as the materials used as adhesives are very well known in the art and need no further description herein.

The application technology can be a simple thermo-transfer process by using a transparent carrier as a transfer carrier and/or as a release protect-ion foil during the thermo-pressure process. This transparent carrier can be peeled off after the application or can stay on top as a protection layer. In the case of keeping it on top of the security element as a protection layer, usually a good adhesion to the substrate is achieved. The transparent carrier in general exhibits a thickness of some micrometers to some millimetres, especially from 1 μm to 800 μm, preferably from 5 to 300 μm and in particular from 10 to 100 μm. The material thereof is in most cases a temperature stable polyester (e.g. PET) foil.

Such foils can be used in a microperforated version to prevent peeling without damaging of the security element. The microperforation can be done by laserperforation, by mechanically punching or by spark erosion.

When the security element of the present invention is in form of a stripe or a label, it can be applied in many different designs and application technologies. Furthermore, since such security elements which are usually very thin (down to 5 to 50 μm) may be stored on rolls, the application can be done with high quality and with high speed onto a substrate.

For example, labels may be conveniently located on a roll which comprises at least one thermostable release layer which is peeled off the security element after application on the surface of the product which is to be secured. By peeling off the release layer of the security element, the surface thereof is free to be exposed to an external stimulus, in particular to the application of humidity, water, chemicals, gases etc. On the other hand, a perforated or porous release layer may be maintained on the security element, since it is able to transmit the external stimuli mentioned above to the volume hologram.

External stimuli like temperature, electrical charge, electrical potential, pressure, magnetism etc. do not need the release layer to be peeled off, since usually it is very thin and does not negatively influence the changes within the holographic structure caused by these stimuli. In the latter case, the release layer may act as a protective layer on the security element.

In general, security elements exhibiting such a protective layer, either porous or not, provide very good protection against abrasion and scratching. Since, on the other hand, such protective layers bearing microperforations may also prevent the peeling of the protective layer without damaging the security element itself (so called tamper evident self-destruction behaviour), the security elements of the present invention which exhibit protective layers are preferred. Of course, these protective layers must be thin and flexible enough to allow volume changes in the volume hologram structure.

The security element of the present invention may also be integrated into a security product of the laminate type or of the injection-mould type, i.e. inside such a product.

The substrate is here e.g. an injection-moulded plastic part or a laminated structure on the base of polymer foils or polymer and paper or cotton based sheets and the like.

The lamination process has to be executed under a strict temperature control in order to avoid destruction of the volume hologram, or, especially when polycarbonate polymers are used, to avoid the yellowing tendency of these polymers when being laminated at temperatures of about 200° C. over a longer period. Such yellowing is especially harmful when security documents are produced which should have a life-time guarantee of at least 10 years, e.g. ID-cards, driver-licenses, passports etc.

When the security element of the present invention is integrated in a laminated or injection moulded security product, external stimuli like temperature, electrical charge, electrical potential, pressure, magnetism etc. may be applied to the security product and cause a change within the volume holo-gram as long as at least one of the layers or protective layers one either one or both sides of the security element is thin and flexible enough in order to allow volume changes in the security element.

When, on the other hand, external stimuli like humidity, water, chemicals, gases etc. shall be applied, at least one of the layers on each side of the security element within the security product must allow a permeability of the external stimulus to the volume hologram in order to cause there at least one change in the physical properties thereof, which is observable by optical changes of the volume hologram. This permeability may be achieved by at least one of a transparent carrier with a perforation therein, especially in form of microholes or a substrate having lateral or horizontal channels therein. Such microholes may be produced by laser beams at a very high speed, e.g. by CO₂-lasers, Nd:YAG lasers and UV-lasers at different wavelength or by spark erosion. Such microholes may exhibit high aspect ratios or may have a conical form whichever is more appropriate. Similarly, also the above mentioned channels in substrates may be produced mechanically.

Preferably, the volume hologram within the security element of the present invention is covered with a substantially transparent overlay structure, which is in particular porous. Of course, a non porous overlay structure may also be used, when the substrate itself is permeable to the external stimulus applied.

The security element of the present invention may also be applied to a security product in combination with a window in such a product, so that the optical effect in form of an image might be observed from either one or both sides of the security element. When applied in a window structure, the security element of the present invention can be covered on either one or both sides thereof with a protective layer. At least one of these layers must be permeable (e.g. porous) to the external stimulus applied thereto. Thus, also the embodiment where the security element is covered at only one side with a protective layer is preferred when humidity, water, chemicals, chemical solutions, gases etc. are used as external stimuli.

Products which may be provided with the security element according to the present invention are in particular security products such as banknotes, passports, identification documents, smart cards, driving licenses, share certificates, bonds, cheques, cheque cards, tax banderols, postage stamps, tickets, credit cards, debit cards, telephone cards, lottery tickets and gift vouchers, but also packing materials, decorative materials, brand products or any other product which has to be secured, e.g. household appliances, spare parts, shoes, clothes, sporting goods, computer hard- and software, pharmaceuticals, cosmetics, spirits, cigarettes, tobacco and the like.

These products may be provided with one or more security elements according to the present invention, which may show similar or different optical effects and whose volume holograms included are responsive to one or more external stimuli of the same or different kind.

Therefore, when the security element of the present invention is used, a high security level may be achieved, since it is easily possible to combine public features which are very easy to handle with features which might merely be recognised and verified by people skilled in the art. All or parts of these features may be interactive security elements according to the present invention.

A further object of the present invention was a process for the verification of a security element according to the present invention.

This object is in a first embodiment achieved by a method for the verification of an interactive security element as described above by an observing unit exhibiting a viewing position with respect to the security element, comprising
illuminating said security element by a light source,
observing an optical effect in the form of a first image at a first viewing angle by using an optical detector,
tilting or otherwise changing the position of the security element relative to the observing unit or changing the viewing position of the observing unit to achieve at a second viewing angle which is different from said first viewing angle,
observing a second different image at the second viewing angle using an optical detector and
comparing said first image with said second image.

The first embodiment of the verification method may be executed prior to the application of an external stimulus and/or after the application of an external stimulus or a first image at a first viewing angle may be observed prior to the application of an external stimulus and a second image at a second viewing angle may be observed after the application of an external stimulus.

In the simplest case, the security element of the present invention does not exhibit any image prior to the application of an external stimulus. Thus, no image may be observed at said first and second viewing angle, respectively, prior to the application of an external stimulus. After an external stimulus has been applied, the security element is illuminated by a light source and with the help of an optical detector, an optical effect in form of an image is observed at a first viewing angle.

The term optical detector has been explained above and the term light source will be explained later.

For the purposes of this invention, the term “viewing angle” means an angle of view which the observing unit (e.g. a person) occupies relative to the interactive security element of the present invention. The first and second viewing angles, respectively, are no particular angles, but angles from which the security element may conveniently be observed by the observing unit. The second viewing angle is merely different from the first viewing angle and is, in most cases, achieved by simply tilting the interactive security means or by otherwise altering its relative position to the observing unit, e.g. by moving the security element up and down, moving the observing unit etc.

When the first image at the first viewing angle has been observed, the security element is e.g. tilted or the viewing position of the observing unit is changed in order to achieve at the second viewing angle, which is different from the first viewing angle.

At the second viewing angle, an optical effect in the form of a second image is observed. Afterwards, the second image at the second viewing angle is compared with the first image at the first viewing angle. The first and the second image must be different from each other as explained above, i.e. the security element of the present invention exhibits an observable optically variable effect after the application of an external stimulus. When the first image and the second image are different in colour and/or intensity and/or brightness and/or object and/or position and/or orientation and/or size and/or apparent depth, and/or perspective and/or parallax, the security element is regarded as being valid.

In a second case, the security element of the present invention exhibits an image at a first viewing angle. Then, an external stimulus is applied and the viewing angle is changed to a second viewing angle as described above. At the second viewing angle, a second image is observable, which is different from the first image at the first viewing angle when both images are compared with each other.

When the first image and the second image are different in colour and/or intensity and/or brightness and/or object and/or position and/or orientation and/or size and/or apparent depth and/or perspective and/or parallax, the security element is regarded as being valid.

In a third case, the security element of the present invention exhibits a first image at the first viewing angle and a second different image at the second viewing angle prior to the application of an external stimulus. Both images may be observed in the way described above, namely by applying the method for verification disclosed. When compared to each other, the first and the second image must be different from each other as explained above, i.e. the security element of the present invention does exhibit an observable optically variable effect prior to the application of an external stimulus.

In a next step, at least one external stimulus is applied to the security element. After that application, the security element is once again observed at the first viewing angle, using an optical detector and an observation unit as described before. Next, at the first viewing angle, a third image is revealed and may be observed. The third image is compared then with the first image which has been observed before at the first viewing angle prior to the application of the at least one external stimulus.

When the first and the third images being observed at the first viewing angle are different in colour and/or intensity and/or brightness and/or object and/or position and/or orientation and/or size and/or apparent depth and/or perspective and/or parallax, the security element is regarded as being valid.

In a further step, the security element may be observed once again at the second viewing angle. There, a fourth image may be revealed which might be observed. The fourth image at the second viewing angle is then compared with the third image at the first viewing angle. When both images are different from each other in colour and/or intensity and/or brightness and/or object and/or position and/or orientation and/or size and/or apparent depth and/or perspective and/or parallax, the interactive security element according to the present invention does exhibit an observable optically variable effect after the application of an external stimulus.

Next, the second and fourth images which have been observed at the second viewing angle are compared to each other. When both images are different in colour and/or intensity and/or brightness and/or object and/or position and/or orientation and/or size and/or apparent depth and/or perspective and/or parallax, the security element is regarded as being valid.

In a second embodiment, the object of the present invention is furthermore achieved by a method for the verification of an interactive security element as described above by an observing unit exhibiting a viewing position with respect to the security element, comprising
illuminating said security element by a light source,
observing an optical effect in the form of a first image at a first viewing angle by using an optical detector,
applying an external stimulus to said security element without altering the position of the security element or the viewing position of the observing unit,
observing an optical effect in the form of a further image at said first viewing angle by an optical detector and
comparing said first image with said further image.

When the second embodiment of the verification method is executed, at least one external stimulus has to be applied.

In the simplest case, the security element of the present invention is observed prior to the application of at least one external stimulus at a first viewing angle, where an optical effect in form of a first image is observed, whereby the security element is illuminated by a light source and an optical detector is used.

Then, an external stimulus is applied to the security element. Following the application of the external stimulus, neither the position of the security element nor the viewing position of the observing unit is changed and a further image may be observed at said first viewing angle, using an optical detector.

The security element is regarded as being valid when the first image and the further image at said first viewing angle are different in colour and/or intensity and/or brightness and/or object and/or position and/or orientation and/or size and/or apparent depth and/or perspective and/or parallax.

The application of an external stimulus may be repeated several times. In fact, n different external stimuli may be applied to the security element of the present invention, whereby z further images are revealed and may be observed, n and z being cardinal numbers equal or greater than 1 and being different or equal to each other. This means that not each and every external stimulus must cause the revealing of a further image that is different from the one seen before the application of that stimulus, as well as that the same external stimulus must not in each case cause the revealing of the same image (e.g. when using humidity as the first and the fourth stimulus, the fourth stimulus may cause an image which is different from the image which has been caused by the first stimulus).

Therefore, the security element is regarded as being valid when said first image and at least one of said z further images which are observed at the first viewing angle are different in colour and/or intensity and/or brightness and/or object and/or position and/or orientation and/or size and/or apparent depth and/or perspective and/or parallax.

As already mentioned before, the security element of the present invention may also exhibit further images at further viewing angles which are different from the first and second viewing angles. In order to reveal these images, the above described methods may be modified in that manner that after the security element has been illuminated by a light source, optionally further images at further viewing angles are observed by tilting or otherwise changing the position of the security element relative to the observing unit or by changing the viewing position of the observing unit or the position of the light source in order to achieve at the further viewing angles. Preferably, such an action is accomplished prior to the application of an external stimulus.

It has to be emphasised again that the reaction time of the interactive security element of the present invention to an external stimulus applied is very short. Therefore, the verification methods described above may also be executed within a very short period of time. As described before, the reaction time is within a period of one tenth of a second up to several seconds, in particular from 0.1 to 10 seconds. Thus, the verification methods according to the present invention may be executed in a time period of some tenth seconds and should not be longer than a minute, depending on the numbers of external stimuli applied. Of course, more than two external stimuli may result in a slightly longer time for the verification of the inter-active security element.

The light source which is used in the verification methods described above is daylight, ambient light, white light, light being composed of one or more specific wavelength, coherent light, pulsed light or modulated light.

The optical detector used in the verification methods of the present invention has been described above with respect to the security element itself. In the simplest form, it is the naked human eye.

Furthermore, the external stimuli which may be used in the methods for verification of the present invention have been described before too. The corresponding passages of the description are referred to here.

The security element of the present invention is the first example of an interactive security element, where the interactivity is due to a volume hologram which is responsive to an external stimulus, ever known.

Although it is relatively easy to produce at low cost, it imparts a very high security level to the products which are provided therewith. The security element is virtually impossible to copy, due to the complexity of the volume hologram and the component parts, as well as due to the difficulty of the method of creating the holographic images by use of coherent beams. Furthermore, external stimuli creating optical effects which are easily visible to the naked eye may be combined with further external stimuli causing optical effects which may only be recognised by persons skilled in the art being in possession of the equipment needed, thereby enhancing the security level to an even greater extent.

Still furthermore, the interactive security element of the present invention exhibits outstanding optical effects which might be easily recognised by the so called “person in the street”, even with the naked eye and without having an original specimen for comparison in hand.

The interactive security element of the present invention is, therefore, an outstanding means for imparting an extreme barrier to counterfeiting and copying and an associated very high security level to products, and in particular to all types of security products.

The following examples are provided for illustrating the present invention and shall not be construed as limitative to the remainder of the disclosure in any way whatsoever.

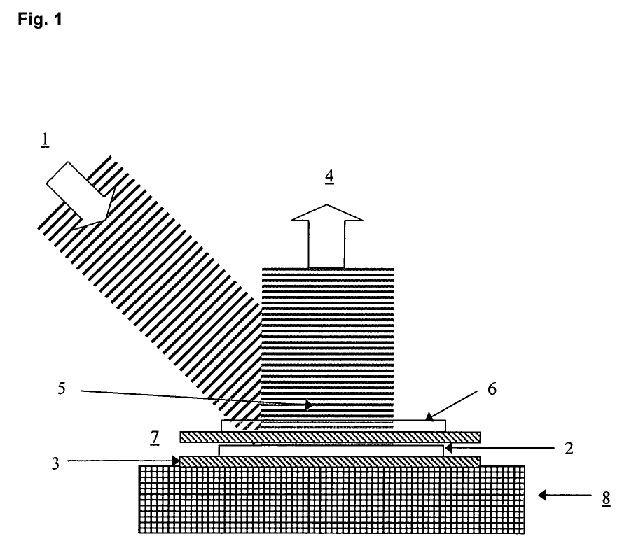

At first, the preparation of a volume hologram out of a reflective contact master hologram in general is explained, which is illustrated by FIG. 1.

A master hologram displaying a left/right switch, such that a first image is visible when the hologram is tilted to the left and a second image when the hologram is tilted to the right, is made by standard mastering techniques well known to the skilled technician. The emulsion layer (2) of the master hologram is typically supported on a glass substrate (3) with the whole set up on a metal plate or an optical bench (8). When laser light (1) of a particular wavelength is incident upon the emulsion layer (2) of the master hologram, at least some of this incident light (4) is reflected by the fringe microstructure within the hologram layer, and produces a standing wave of interference (5) in the space where the coherent incident and reflected light coincide. When a second hologram recording medium, comprising a photo-sensitive layer (6) of the appropriate spectral sensitivity, which is typically located upon a PET or triacetate carrier film (7) is supported in a stable position in contact or slightly displaced from the surface of the master hologram, the interference between the incident and reflected waves is recorded in the photosensitive layer of the second hologram recording medium. This recording is capable of reconstructing predominantly the same image as was seen in the master hologram, whereby some minor positional difference dependent upon the spacing of the second hologram layer and the master hologram may occur.

### EXAMPLE 1

Two reflective master holograms are produced, using the standard methods known by the person skilled in the art. The first master hologram, displaying a left/right switch as explained above, reveals a first image in the form of a MERCK-logo when tilted to the left and a second image in the form of the wording “hologram” when tilted to the right. The second master hologram, also displaying a left/right switch, reveals a first image in the form of the word “valid” when tilted to the left and a second image in the form of the word “secure” when tilted to the right.

As a recording medium for producing a volume hologram being responsive to at least one external stimulus, a silver halide holographic film is used, being composed of a gelatin film containing fine silver halide grains having a grain size of about 10-20 nm which has been coated in a dry thickness of about 10 μm on a triacetylcellulose base being of a thickness of about 200 μm. The gelatin emulsion as such can be prepared following standard methods such as those outlined in e.g. H. I. Bjelkhagen, Silver halide recording materials, Springer-Verlag, Berlin 1993, and can then be coated onto a suitable PET or triacetate substrate.

The silver halide holographic film mentioned above is positioned on top of the first master hologram and the whole set is exposed to red laser light, for example a 633 HeNe laser, in a standard contact copying set up, such that the appropriate stability is organised for the whole system during the exposure (according to FIG. 1). Then, the contact copy film is removed and kept in a dark place prior to the second exposure.

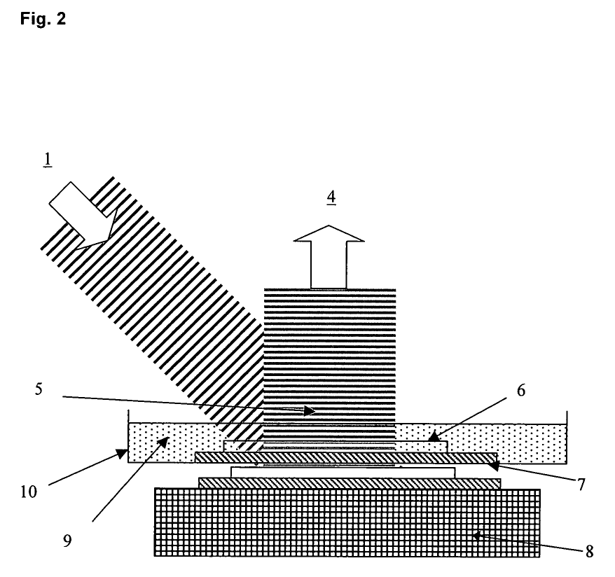

The second master hologram is then placed in the copying rig. An optically transparent shallow, water (9) filled dish (10) is placed on top of the second master hologram and the previously exposed contact copy film containing a latent image of the first's master content is then placed recording side up in the dish in such a manner that the images from the first exposure will be in registration with those from the second. After allowing time for the recording material to expand under the influence of water, the set up is exposed to laser light for a suitable time. The characteristics of the second recording are illustrated by FIG. 2. All integers identical to those used in FIG. 1 indicate the same features as in FIG. 1.

The contact copy film is then removed and developed and bleached in a standard manner. This might be done e.g. by developing in a low solvent developer such as D19b of Kodak or in CW-C2 of Fuji Film, bleaching in a solution such as ferric sulphate or ferric EDTA, followed by washing, usually with water, and drying. Thereby, a volume hologram being responsive to water as an external stimulus is achieved.

The resulting holographic film, when exposed to normal white light, will display the MERCK-logo when tilted to the left at a first viewing angle and the wording “hologram” when tilted to the right at a second viewing angle, when being dry, under observation with the naked eye.

After immersing the holographic film in water (or after wetting the surface of the holographic film with water), the first two images will disappear. Instead, a third image being in the form of the wording “valid” will be seen when the hologram is tilted to the left at a viewing angle which is nearly identical to the first viewing angle and the wording “secure” will be seen when the hologram is tilted to the right at a viewing angle which is nearly identical to the second viewing angle.

Depending on the range of laser sensitivity of the holographic recording film and on the type and number of colour forming compounds in the gelatin base thereof, the volume hologram prepared according to the method explained above may exhibit coloured images, being of the same or of different colours. To this end, the recording of the first and of the second step can be done with equal or different types of lasers. Additionally, all images can be recorded in a 3-dimensional manner. The example using the different wordings has been used for the simplicity of explanation only.

### EXAMPLE 2

An aqueous solution of gelatin, containing 15% by weight of gelatin, is coated on a subbed PET film to a dry thickness of approximately 250 μm. The coating is hardenend for 3 minutes in a 1% (by weight) glutaraldehyde solution. The film is first soaked in a 0.3M silver nitrate solution. After soaking the film, the surface solution is wiped off and finally dried under hot air. Afterwards, the film is soaked in a solution of 3% (by weight) lithium bromide and 0.05% (by weight) ascorbic acid containing a methanolic solution of pinacyanol dye. The film is then washed with deionised water and sensitised by agitation in a solution of 5% (by weight) sodium ascorbate for 20 seconds, rinsed and dried (the production scheme disclosed in J. Blyth et. al., Imaging Science Journal, 1999, 47(2), pages 87-91, may be followed).

The resulting film is used to make a holographic contact copy, using the process according to step 2 mentioned in example 1 above, which is illustrated by FIG. 2. As a master hologram, the second master hologram mentioned above is used.

After the exposure to a red HeNe (633 nm) laser light and the following developing, bleaching and washing procedure, the resulting hologram is dried.

The resulting holographic film, when exposed to normal white light, will display no image when tilted to the left at a first viewing angle and no image when tilted to the right at a second viewing angle, when being dry and being observed with the naked eye.

After immersing the holographic film in water (or after wetting the surface of the holographic film with water), a first image being in the form of the wording “valid” will be seen when the hologram is tilted to the left at a viewing angle which is nearly identical to the first viewing angle and a second image in the form of the wording “secure” will be seen when the hologram is tilted to the right at a viewing angle which is nearly identical to the second viewing angle.

1. Interactive security element comprising at least one volume hologram, that is responsive to at least one applied external stimulus and exhibits at least one defined optical effect in the form of an image in response to application of the at least one external stimulus to the volume hologram.

2. (canceled)

3. Security element according to claim 1, wherein in the absence of the at least one external stimulus, a first image is observable at a first viewing angle and in response to an application of the at least one external stimulus a second different image is observed at a second viewing angle.

4. Security element according to claim 1, wherein in the absence of the at least one external stimulus, a first and a second image is observable at a first and a second viewing angle, respectively, and in response to an application of the at least one external stimulus a third image is revealed that is observable at the first viewing angle.

5. Security element according to claim 4, wherein in response to an application of an additional external stimulus a fourth image is revealed that is observable at the second viewing angle.

6. Security element according to claim 4, wherein in response to an application of n different external stimuli z additional further images are revealed that are observable at the first viewing angle, wherein n and z are cardinal numbers equal or greater than 1 and are different or equal to each other.

7. Security element according to claim 8, further comprising one or more additional further images that are observable at one or more further viewing angles being different from first and second viewing angles, the first and second images and the one or more additional further images are different in colour and/or intensity and/or brightness and/or object and/or position and/or orientation and/or size and/or perspective and/or parallax and/or apparent depth.

8. Security element according to claim 3, wherein the first and second images observable at the first viewing angle and the second viewing angle respectively, are different in colour and/or intensity and/or brightness and/or object and/or position and/or orientation and/or size and/or apparent depth and/or perspective and/or parallax.

9-10. (canceled)

11. Security element according to claim 1, wherein at least one of humidity, water, gases, vapours, organic solvents, chemicals, solutions or dispersions of chemicals, pressure, temperature, light of particular wavelengths, magnetism, electrical field, electrical charge, electrical potential, non-ionising radiation, electromagnetic radiation, radioactive radiation, enzymes, biological materials and combinations of one or more thereof, optionally varying in degree or intensity, is applied as the at least one external stimulus.

12. Security element according to claim 1, wherein the volume hologram is composed of a polymeric support medium having a light diffractive structure embedded therein and exhibiting at least one change or variation in at least one physical property of the polymeric support medium and/or the light diffractive structure in an event the at least one external stimulus is applied.

13. Security element according to claim 12, wherein the physical property is one or more of size, shape, density, strength, hardness, hydrophobicity, swellability, integrity, polarizability, charge distribution, refractive index, and combinations thereof.

14. Security element according to claim 13, wherein the at least one change or variation in at least one physical property is observable as a change or variation in the reflectance and/or refractance and/or absorbance and/or polarizability of the light diffractive structure.

15. Security element according to claim 14, wherein the change or variation in the at least one physical property is reversible, partly reversible or irreversible.

16. Security element according to any one or more of claims 15, wherein the image is observable using an optical detector selected from the unassisted naked eye; the naked eye assisted by spectacles, magnifying lenses, microscopes, lenticular lenses, polarizing filters, diffractive structures, wavelength filter elements or light enhancing systems; spectrophotometers; spectrum analyzers; CCD-sensors; CMOS-sensors, OCR-readers, bar code readers, cameras and image recognisers.

17. Security element according to claim 1, wherein the image is a holographic representation of an object.

18. Security element according to claim 17, wherein the object is one or more of a mirror, a reflective surface, an alphanumeric or other character, a microtext, a picture, a photo, a bar code, a physical object, a logo, a trade mark, a computer generated picture, a computer generated object and projections thereof.

19. Security element according to claim 1 is a label and/or a patch and/or a stripe and/or a thread.

20. Security element according claim 19 is applied to a surface of a product by an adhesive, a pressure sensitive adhesive, a hot-melt adhesive, a reactive or partly reactive hot-melt adhesive or combinations thereof.

21-26. (canceled)

27. Use of a security element according to claim 1 for verification and/or identification and/or authentication and/or anti-counterfeiting purposes.

28. Use of a security element according to claim 26 for the verification and/or identification and/or authentication and/or anti-counterfeiting of a product.

29. Product, containing a security element according to claim 1.

30. (canceled)

31. Method for verifying a security element comprising
illuminating a security element by a light source, the security element comprising at least one volume hologram that is responsive to at least one applied external stimulus and exhibits at least one defined optical effect in the form of an image in response to an application of the at least one external stimulus to the volume hologram;
observing an optical effect in the form of a first image at a first viewing angle;
tilting or otherwise changing the position of the security element to achieve a second viewing angle different from the first viewing angle,
observing a second image at the second viewing; and
comparing the first image with the second image to verify the security element.

32. Method according to claim 31, wherein observing and comparing the first and second images includes observing and comparing the first and second images in an absence of an application of the at least one external stimulus.

33. Method according to claim 31, wherein observing and comparing the first and second images includes observing and comparing the first and second images in response to an application of the at least one external stimulus.

34. Method according to claim 31, wherein observing and comparing the first image includes observing the first image in an absence of an application of the at least one external stimulus, and wherein observing the second image includes observing the second image in response to an application of the at least one external stimulus.

35. Method according to claim 31, wherein observing and comparing the first and second images includes observing and comparing the first and second images in an absence of an application of the at least one external stimulus, and further includes observing a third image at the first viewing angle in response to an application of the at least one external stimulus, and comparing the third image with the first image.

36. Method according to claim 35, further includes:
observing a fourth image at the second viewing angle in response to an application of the at least one external stimulus;
comparing the third and fourth images with each other,
comparing the first image with the third image; and
comparing the second image with the fourth image.

37. Method according to claim 35, wherein the result from comparing is that the security element is valid in an event of the first and third images that are observed at the first viewing angle are different in colour and/or intensity and/or brightness and/or object and/or position and/or orientation and/or size and/or apparent depth and/or perspective and/or parallax.

38. Method according to claim 36, wherein the result from comparing is that the security element is valid in an event of the second and fourth images that are observed at the second viewing angle are different in colour and/or intensity and/or brightness and/or object and/or position and/or orientation and/or size and/or apparent depth and/or perspective and/or parallax.

39. Method according to claim 31, wherein the result from the comparing is that the security element is valid in an event of the first and second images that are observed at the first and second viewing angles, respectively are different in colour and/or intensity and/or brightness and/or object and/or position and/or orientation and/or size and/or apparent depth and/or perspective and/or parallax.

40. Method for verifying a security element comprising
illuminating a security element by a light source, the security element comprising at least one volume hologram that is responsive to at least one applied external stimulus and exhibits at least one defined optical effect in the form of an image in response to an application of the at least one external stimulus to the volume hologram;
observing an optical effect in the form of an image at a viewing angle;
applying the at least one external stimulus to the security element without altering the position of the security element,
observing an optical effect in the form of a an other image at the viewing angle; and
comparing the image with the other image to verify the security element.

41. Method according to claim 40, wherein applying the at least one external stimuli and observing the other image includes applying n different external stimuli and observing z further images at the viewing angle, n and z are cardinal numbers equal or greater than 1 and are different or equal to each other.

42. Method according to claim 40, wherein the result from comparing is that the security element is valid in an event of the image and the other image that are observed at the viewing angle are different in colour and/or intensity and/or brightness and/or object and/or position and/or orientation and/or size and/or apparent depth and/or perspective and/or parallax.

43. Method according to claim 41, wherein the result from comparing is that the security element is valid in an event of the image and at least one of the z further images that are observed at the viewing angle are different in colour and/or intensity and/or brightness and/or object and/or position and/or orientation and/or size and/or apparent depth and/or perspective and/or parallax.

44. Method according claim 43 further includes observing at least one further optical effect in the form of a further image at least one further viewing angle that is different from the viewing angle, the at least one further viewing angle is achieved by tilting or otherwise changing the position of the security element or position of the light source.

45. Method according to claim 44, wherein observing includes observing the at least one further optical effect in response to an application of the at least one external stimulus.

46. Method according claim 31, wherein at least one of humidity, water, gases, vapours, organic solvents, chemicals, solutions or dispersions of chemicals, pressure, temperature, light of particular wavelengths, magnetism, electrical field, electrical charge, electrical potential, non-ionising radiation, electromagnetic radiation, radioactive radiation, enzymes, biological materials and combinations of one or more thereof, optionally varying in degree or intensity, is applied as the at least one external stimulus.

47. Method according to claim 31, wherein the light source is daylight, ambient light, white light, light being composed of one or more specific wavelength, coherent light, pulsed light or modulated light.

48. Method according to claim 31, wherein observing the first image at the first viewing angle and observing the second image at the second viewing angle is performed by an optical detector selected from the unassisted naked eye; the naked eye assisted by spectacles, magnifying lenses, microscopes, lenticular lenses, polarizing filters, diffractive structures, wavelength filter elements or light enhancing systems; spectrophotometers; spectrum analyzers; CCD-sensors; CMOS-sensors, OCR-readers, bar code readers, cameras and image recognisers.

49. (canceled)

50. Method according claim 40, wherein at least one of humidity, water, gases, vapours, organic solvents, chemicals, solutions or dispersions of chemicals, pressure, temperature, light of particular wavelengths, magnetism, electrical field, electrical charge, electrical potential, non-ionising radiation, electromagnetic radiation, radioactive radiation, enzymes, biological materials and combinations of one or more thereof, optionally varying in degree or intensity, is applied as the at least one external stimulus.

51. Method according to claim 40, wherein the light source is daylight, ambient light, white light, light being composed of one or more specific wavelength, coherent light, pulsed light or modulated light.

52. Method according to claim 40, wherein observing the image and the other image at the viewing angle is performed by an optical detector selected from the unassisted naked eye; the naked eye assisted by spectacles, magnifying lenses, microscopes, lenticular lenses, polarizing filters, diffractive structures, wavelength filter elements or light enhancing systems; spectrophotometers; spectrum analyzers; CCD-sensors; CMOS-sensors, OCR-readers, bar code readers, cameras and image recognisers.
